(19) United States
(12) Patent Application Publication
(10) Pub. No.: US 2019/0236719 A1
(43) Pub. Date: Aug. 1, 2019

(54) SELECTIVE IDENTIFICATION OF SOCIAL NETWORK CONNECTIONS

(71) Applicant: Microsoft Technology Licensing, LLC, Redmond, WA (US)

(72) Inventors: Aastha Jain, Sunnyvale, CA (US); Hema Raghavan, Mountain View, CA (US); Mengda Yang, Sunnyvale, CA (US)

(21) Appl. No.: 15/885,210

(22) Filed: Jan. 31, 2018

(51) Int. Cl. G06Q 50/00; G06F 3/048; G06F 17/30; G06F 15/18

(52) U.S. Cl. CPC G06Q 50/01; G06F 15/18; G06F 17/3053; G06F 3/048

(57) ABSTRACT

Systems, devices, media, and methods are presented for identifying and facilitating connections in a social network. The systems and methods identify a plurality of unconnected members having a number of associations below a first threshold and identify a specified member with a number of associations above a second threshold. The systems and methods determine one or more connected members having an attenuated association with the specified member and identify a set of presentation positions within a graphical user interface. The systems and methods determine a presentation trigger selecting a connection type of a set of members to be presented to the specified member. Based on the presentation trigger, the systems and methods select an unconnected member for presentation within the set of members and cause presentation of the unconnected member within a presentation position.

### TECHNICAL FIELD

Embodiments of the present disclosure relate generally to the technical field of facilitating dynamically modifying a graphical user interface Specifically, the present disclosure describes systems and methods to identify and facilitate connections for unconnected members within a social network by dynamic generation and assignment of graphical user interface icons

### BACKGROUND

Network-based publication systems enable users to publish documents, pages, and other content. Users may access and view published content on the network-based publication system via a network linking the network-based publication system to a client device. A social networking system allows members to declare information about themselves, such as their professional qualifications or skills. In addition to information the members declare about themselves, a social networking system may gather and track information pertaining to behaviors of members with respect to the social networking system and social networks of members of the social networking system. Analyzing a vast array of such information may help to formulate solutions to various problems that may not otherwise have clear solutions

### BRIEF DESCRIPTION OF THE SEVERAL VIEWS OF THE DRAWINGS

Some embodiments are illustrated by way of example and not limitation in the: accompanying drawings, in which:

FIG. 1 is a block diagram of the functional components that comprise a computer- or network-based social networking system, including a network analysis machine, consistent with some embodiments described herein;

FIG. 2 is a block diagram depicting components of the network analysis machine of FIG. 1, in accordance with an example embodiment;

FIG. 3 is a flow diagram illustrating a method of identifying and facilitating connections for unconnected members within a social network, according to some embodiments of the present disclosure;

FIG. 4 is a flow diagram illustrating a method of identifying and facilitating connections for unconnected members within a social network, according to some embodiments of the present disclosure;

FIG. 5 is a flow diagram illustrating a method of identifying and facilitating connections for unconnected members within a social network, according to some embodiments of the present disclosure; and

FIG. 6 is a block diagram of a machine in the form of a computing device within which a set of instructions, for causing the machine to perform any one or more of the methodologies discussed herein, may be executed.

### DETAILED DESCRIPTION

Example methods and systems are shown for analyzing a social network to predict queries, rankings, and other actions on data sets within a networked system. In some embodiments, the methods and systems described herein enable analysis of a social network to predict member actions within a social networking system. In some example embodiments, a first member of a social network logs one or more changes to a data set (e.g., a member profile) in a social networking system. The one or more changes may correspond to a specified element or element type, such as a job or employment status. A network analysis machine enables identification of unconnected members or members associated with the social network. The unconnected members may be members of the social network who are not regularly recommended to other members for establishing a connection, association, or other relationship. The network analysis machine may exploit exploration algorithms to generate connection recommendations tailored to members of the social network.

In one aspect of the present disclosure, systems and methods are described to recommend members of a social network to one another. In some embodiments, a first member interacts with the social network. The network analysis machine identifies a group of members connected to the first member. The network analysis machine then identifies unexposed or unconnected members of the social network The unconnected members are identified using historical data of members across the social network. The network analysis machine identifies one or more of the unconnected members who are likely to be known by or otherwise connected to the first member. The unconnected members may then be selectively recommended to the first member within a structured graphical user interface in a manner tailored to the first member.

For example, Jeff may be a member of the social network and have a large number of connections to other members within the axial network. Bob, another member of the social network, may be unconnected or have a small number of connections to members of the social network. Jeff may frequently interact with the social network through an applications, while Bob seldom logs into the application Aspects of a network anaylsis system of the present disclosure may surface Bob in a recommendation list of members with whom Jeff may like to connect or with whom Jeff may have some relationship. Bob may be identified through an attenuated connection, a common interest, or other suitable information or member history. When Jeff selects Bob for connection, aspects of the present disclosure may send a notification to Bob, and surface Bob as a recommended connection to other members of the social network. In some embodiments, Bob may be a new member with no previous social network connections. In such embodiments, aspects of the present disclosure may estimate a likelihood that, upon presentation of Bob as a recommended member, Jeff will select Bob for connection. Further, in recommending Bob to Jeff, an identifier or member name of Bob may be selectively placed in a graphical user interface most likely to receive a selection by Jeff. When Jeff selects Bob as a connection, the network analysis system may present a notification to Bob, causing Bob to interact with the social network. In some instances, Bob's reach within the social network is increased through the connection with Jeff. The reach may enable or cause Bob to organically be presented in an increased number of recommendations to members of the social network. The increased reach may also enable Bob to organically grow his personal social network (e.g., a network of connections within the social network) more quickly.

Social networking systems provide various profile options and services. In some instances, a social network may connect members (e.g., individuals associated with the social network) and organizations alike. Social networking services have also become a popular method of reconnecting with or finding people with whom a member of the social network has lost contact. Recommendations, representing a possible connection or commonality between two members, may be identified by characteristics, attributes, interests, or other aspects of the respective members.

A social networking system may have a vast array of information pertaining to members of the social networking system, companies maintaining a social networking presence on the social networking system, and interactions between members, companies, and content provided by both the members and companies to the social networking system. As will be discussed in more detail below, information pertaining to members of the social networking system can include data items pertaining to education, work experience, skills, reputation, certifications, and other qualifications of each of the members of the social networking system at particular points during the careers of these members, or interaction data indicating a history of interactions with content on the social networking system. This information pertaining to members of the social networking system may be member-generated to enable individualization of social networking profiles as well as to enable dynamic and organic expansion and discovery of fields of experience, education, skills, and other information relating to personal and professional experiences of members of the social networking system.

Other aspects of the present inventive subject matter will be readily apparent from the description of the figures that follow.

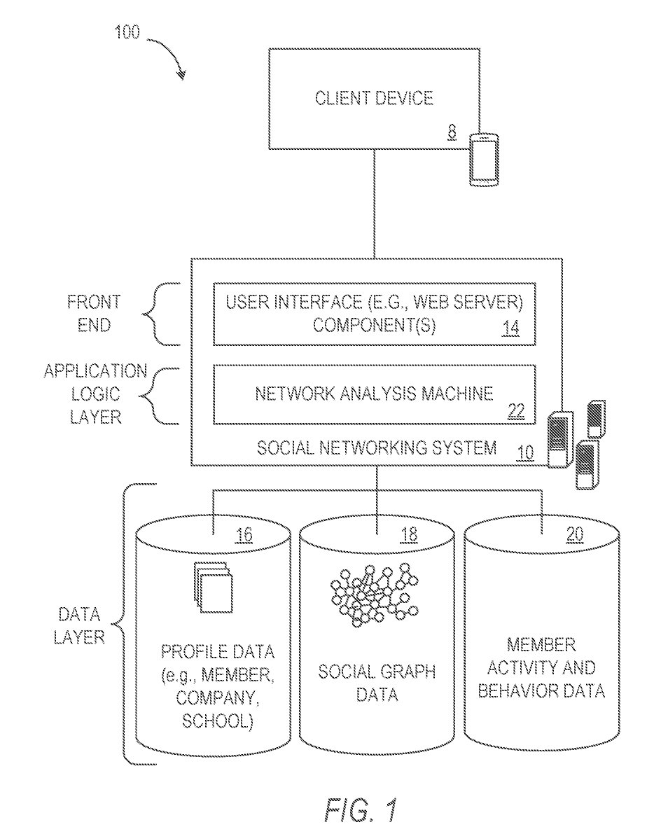

FIG. 1 is a block diagram 100 of the functional components that comprise a computer- or network-based social networking system 10, consistent with some embodiments of the inventive concepts of the present disclosure. In some embodiments, the social networking system 10 acts as a network-based publication system. In these instances, as shown in FIG. 1, the social networking system 10 is generally based on a three-tiered architecture, comprising a front end layer, application logic layer, and data layer. As is understood by skilled artisans in the relevant computer and Internet-related arts, each component or engine shown in FIG. 1 represents a set of executable software instructions (e.g., an instruction set executable by a processor) and the corresponding hardware (e.g., memory and a processor) for executing the instructions. To avoid obscuring the inventive subject matter, various functional components and engines that are not germane to conveying an understanding of the inventive subject matter have been omitted from FIG. 1. However, a skilled artisan will readily recognize that various additional functional components and engines may be used with a social networking system 10, such as that illustrated in FIG. 1, to facilitate additional functionality that is not specifically described herein. Furthermore, the various functional components and engines depicted in FIG. 1 may reside on a single server computer, or may be distributed across several server computers in various arrangements. Moreover, although the social networking system 10 is depicted in FIG. 1 as having a three-tiered architecture, the inventive subject matter is by no means limited to such an architecture.

As shown in FIG. 1, the front end comprises a user interface component 14 (e.g., a web server), which receives requests from various client devices 8, and communicates appropriate responses to the requesting client devices 8. For example, the user interface component 14 may receive requests in the form of Hypertext Transfer Protocol (HTTP) requests or other web-based application programming interface (API) requests. The client devices 8 may be executing conventional web browser applications or applications that have been developed for a specific platform to include any of a wide variety of mobile devices and operating systems.

As shown in FIG. 1, the data layer includes several databases, including one or more databases 16 for storing data relating to various entities represented in a social graph. In some embodiments, these entities include members, companies, and/or educational institutions, among possible others. Consistent with some embodiments, when a person initially registers to become a member of the social networking service (e.g. a part of, extension of, or interface associated with the social networking system 10), and at various times subsequent to initially registering, the person will be prompted to provide some personal information, such as his or her name, age (e.g., birth date), gender, interests, contact information, home town, address, spouse's and/or family members' names, educational background (e.g. schools, majors, etc.), current job title, job description, industry, employment history, skills, professional organizations, and so on. This information is stored as part of a member's member profile, for example, in the database 16. In some embodiments, a member's profile data will include not only the explicitly provided data, but also any number of derived or computed member profile attributes and/or characteristics.

Once registered, a member may invite other members, or be invited by other members, to connect via the social networking service A “connection” may mean a bilateral agreement by the members, such that both members acknowledge the establishment of the connection. Similarly, in some embodiments, a member may elect to “follow” another member. In contrast to establishing a “connection,” “following” another member typically is a unilateral operation and, at least in some embodiments, does not include acknowledgement or approval by the member who is being followed. When one member follows another, the member who is following may receive automatic notifications about various activities undertaken by the member being followed. In addition to following another member, a member may elect to follow a company, a topic, a conversation, or some other entity. In general, the associations and relationships that a member has with other members and other entities (e.g., companies, schools, etc.) become part of the social graph data maintained in a database 18. In some embodiments, a social graph data structure may be implemented with a graph database (e.g., the database 18), which is a particular type of database that uses graph structures with nodes, edges, and properties to represent and store data. In this case, the social graph data stored in the database 18 reflects the various entities that are part of the social graph, as well as how those entities are related with one another.

In various alternative embodiments, any number of other entities might be included in the social graph, and, as such, various other databases may be used to store data corresponding with the other entities. For example, although they are not shown in FIG. 1, consistent with some embodiments, the social networking system 10 may include additional databases for storing information relating to a wide variety of entities, such as information concerning various online or offline groups, job listings or postings, photographs, audio or video files, and so forth.

In some embodiments, the social networking service may include one or more activity and/or event-tracking components, which generally detect various member-related activities and/or events, and then store information relating to those activities/events in a database 20. For example, the tracking components may identify when a member makes a change to some attribute of his or her member profile or adds a new attribute. Additionally, a tracking component may detect the interactions that a member has with different types of content. Such information may be used, for example, by one or more recommendation engines to tailor the content presented to a particular member, and generally to tailor the member experience for a particular member.

The application logic layer includes various application server components, which, in conjunction with the user interface component 14, generate various user interfaces (e.g., web pages) with data retrieved from various data sources in the data layer. In some embodiments, individual application server components are used to implement the functionality associated with various applications, services, and features of the social networking service. For instance, a messaging application, such as an email application, an instant messaging application, a social networking application native to a mobile device, a social networking application installed on a mobile device, or some hybrid or variation of these, may be implemented with one or more application server components implemented as a combination of hardware and software elements. Of course, other applications or services may be separately embodied in their own application server components.

As shown in FIG. 1, a network analysis machine 22 is an example application server component of the social networking system 10. The network analysis machine 22 performs operations to identify and facilitate connections for unconnected members within a social network. In some embodiments, the network analysis machine 22 operates in conjunction with the user interface components 14 to receive sets of publication data, sets of member data, and member input to generate tailored user interface presentations including information, relating to unconnected members selected from members of the social networking system 10, presented in selected areas (e.g., presentation positions) likely to be selected by another member. For example, the network analysis machine 22 may render graphical representations of icons or other representations of selected unconnected members in varied presentation positions and having a varied relationship to the member to whom the selected unconnected members are being presented.

The social networking system 10 may provide a broad range of applications and services that allow members the opportunity to share and receive information, often customized to the interests of the member. For example, in some embodiments, the social networking system 10 may include a photo sharing application that allows members to upload and share photos with other members, or a slide sharing application, which allows members to upload slide decks for sharing among other members. In some embodiments, members of the social networking system 10 may be able to self-organize into groups, or interest groups, organized around a subject or topic of interest. Accordingly, the data for a group may be stored in a database (not shown). When a member joins a group, his or her membership in the group will be reflected in the social graph data stored in the database 18. In some embodiments, members may subscribe to or join groups affiliated with one or more companies. For instance, in some embodiments, members of the social networking system 10 may indicate an affiliation with a company at which they are employed, such that news and events pertaining to the company are automatically communicated to the members. In some embodiments, members may be allowed to subscribe to receive information concerning companies other than the company with which they are employed. Here again, membership in a group, a subscription or following relationship with a company or group, and an employment relationship with a company are all examples of the different types of relationships that may exist between different entities, as defined by the social graph and modeled with the social graph data of the database 18.

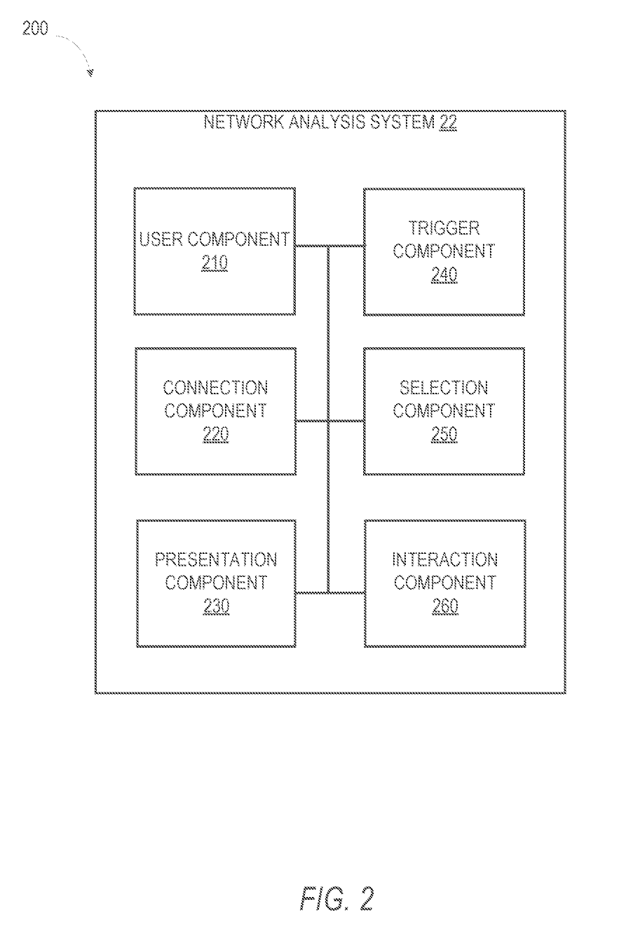

FIG. 2 is a block diagram 200 depicting some example components of the network analysis machine 22 of FIG. 1. The network analysis machine 22 is shown including a user component 210, a connection component 220, a presentation component 230, a trigger component 240, a selection component 250, and an interaction component 260, all configured to communicate with each other (e.g., via a bus, shared memory, a switch, or a network). The user component 210 identifies members within the social network and analyzes profile attributes of the identified members. The connection component 220 determines connections extending between members of the social network. The presentation component 230 may generate and cause presentation of graphical user interfaces on computing devices with which members interact. The trigger component 240 determines presentation triggers enabling selection of differing types of members for presentation to a specified member. The selection component 250 selects members for presentation to a specified member based on presentation triggers, connections, and profile attributes of members. The interaction component 260 detects and interprets member interactions with profile information presented within specified areas of a graphical user interface.

Any one or more of the components described herein may be implemented using hardware (e.g., one or more processors specifically configured to perform the operations described herein) or a combination of hardware and software, forming a hardware-software implemented component. For example, any component described herein may configure a processor (e.g., among one or more processors of a machine) as a special-purpose machine, during the pendency of a set of operations, to perform the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

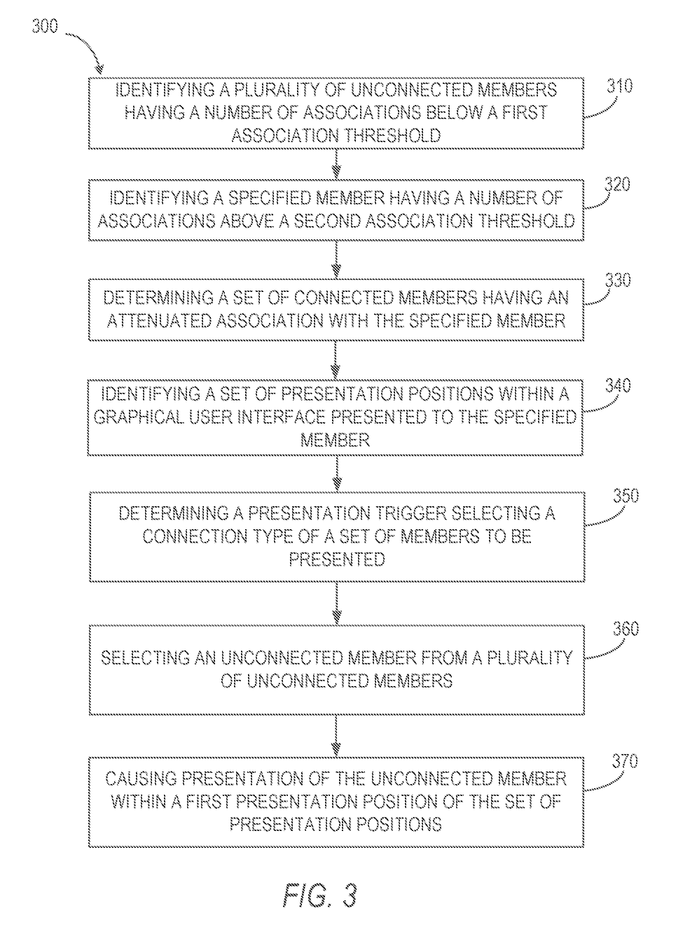

FIG. 3 is a flow diagram illustrating an example method 300 of identifying and facilitating connections for unconnected members within a social network, consistent with various embodiments described herein. For example, the method 300 may comprise identifying a set of unconnected members of a social network and a specified member to whom unconnected members may be presented, and selecting an unconnected member of the set of unconnected members to present to the specified member. The method 300 may be performed, at least in part, by, for example, the network analysis machine 22 illustrated in FIG. 2 (or an apparatus having similar components or operative programming, such as one or more client machines or application servers).

In operation 310, the user component 210 identifies a plurality of unconnected members. The plurality of unconnected members may have a number of associations below a first association threshold. The associations represent friendships, relationships, or other connections between members of a social networking system The user component 210 may identify the plurality of unconnected members at defined intervals, such as during, server maintenance periods, weekly, daily, at a specified time of day, hourly, or at any other suitable interval. In some embodiments, the user component 210 identities unconnected members as the members create a profile or account with the social networking system. The user component 210 may then periodically determine if a member, previously identified as an unconnected member, remains an unconnected member based on the first association threshold.

The first association threshold may be generated as a function of or based on associations or connections available within the social networking system 10. For example, the first association threshold may be a set number of associations. In such instances, the first association threshold may be any suitable or specified number of connections or associations. The unconnected members may have no connection to other members of the social network, or a number of connections below the specified threshold. The first association threshold may also be generated as a function of recommendations. For example, the first association threshold may be generated as a number of connections or associations corresponding to a member being recommended to other members a specified number of times within a specified time period. In such instances, the member may be recommended or not recommended based on a status of falling below or exceeding, respectively, the first association threshold. In some embodiments, one or more unconnected members of the plurality of unconnected members are associated with a connected member of one or more connected members, as described in mere detail below.

In operation 320, the user component 210 identifies a specified member having a number of associations above a second association threshold. In some embodiments, the user component 210 identifies the specified member as a member currently engaging or interacting with the social networking system 10. For example, when a member logs in to the social network, the user component 210 of the network analysis machine 22 may receive or otherwise identify the member and determine that the member has a number of associations above the second association threshold. The second association threshold may be a number of connections within the social network. For example, a number of associations exceeding the second association threshold may indicate that the specified member is well connected. The second association threshold may also be generated based on a reach of the connections of the specified member. For example, the reach of the specified member's connections may represent a number of members to whom an unconnected member may be exposed or provided as a recommendation based on a connection to the specified member.

In operation 330, the connection component 220 determines a set of connected members associated with the specified member. The set of connected members may have an attenuated association with the specified member. In some embodiments, the attenuated association is an indirect association or connection between the set of connected members and the specified member. The indirect association may include at least one intervening member, associations with whom serve to connect the set of connected members with the specified member.

In some embodiments, the set of connected members are connected to the specified member indirectly. Members directly connected to the specified member may be understood as primary connections. Members indirectly connected to the specified member (e.g., connected to the specified member based on an intervening connection to one or more members who are primary connections of the specified member) may be understood to have an attenuated association with the specified member. The connected members may be secondary connections (e.g., connected to a primary connection of the specified member), tertiary connections (e.g., connected to a secondary connection of the specified member), or any other suitable connection.

The connection component 220 may determine the set of connected members by first identifying primary connections of the specified member. The primary connections may be identified or determined based on association information contained within a member profile of the specified member. Once the primary connections are identified, the connection component 220 may identify one or more secondary connections, tertiary connections, or other members having an attenuated connection or association with the specified member formed by associations linked by intervening members.

In some embodiments, as part of operation 320, members having a number of associations below the second association threshold are identified. The members identified as having fewer associations than the second association threshold may be assigned to a common set or pool. For example, the set of connected members identified in operation 330 may be included in an association pool, the association pool comprising members having a number of associations below the second association threshold. As part of operations 320 and 330, a first set of members, including the set of connected members, within a plurality of members may be identified as having or being associated with a number of other members below the second association threshold. The individuals included in the set of members may have a connection to the specified member of operation 320 which is attenuated. The connected members may be assigned to an association pool. The association pool may be understood as a group of members designated as potential connections to the specified member and designated for presentation to other members of the social network. Additionally, in some instances, unconnected members may be assigned to the association pool. In some instances members may be assigned to the association pool for a period of time or based on an associated number of connections. For example, after presentations of a member result in a number of connections for an unconnected member or a connected member above the second association threshold, the unconnected member or the connected member may be removed from the association pool.

In operation 340, the presentation component 230 identifies a set of presentation positions within a graphical user interface presented to the specified member. The set of presentation positions may be configured for presenting member information of a plurality of members to the specified member. As described in more detail below, the presentation component 230 may identify a number of presentation positions within the set of presentation positions, and may identify a type of presentation position. In some instances, the presentation component 230 selects one or more presentation positions of the set of presentation positions to assign a specified type.

In some embodiments, the graphical user interface contains the set of presentation positions generated based on characteristics or aspects of a user device on which the graphical user interface is being presented. For example, a number, size, and orientation of the set of presentation positions may be generated based on a size, dimensions, a screen orientation, and a type of the user device on which the graphical user interface is being presented. The presentation component 230 may identify one or more of a position and a number of presentation positions within the graphical user interface or to be presented within the graphical user interface prior to movement of the presentation positions into a viewable position.

In some embodiments, the presentation component 230 identifies a first portion of presentation positions and a second portion of presentation positions from the set of presentation positions. The first portion of presentation positions may be exploration positions configured to present or be populated with information for one or more unconnected members. In some embodiments, the first portion of presentation positions includes a limited number of presentation positions, such that a greater number of presentation positions of the set of presentation positions are dedicated to presenting information for members having a strong potential association with the specified member and a high relevancy value relative to the specified member. The first portion of presentation positions may comprise a specified number of presentation positions fewer than the number of presentation positions in the set of presentation positions or the second portion of presentation positions. In some embodiments, a single presentation position or small number of presentation positions are included in the first portion of presentation positions. Where the presentation component 230 selects the type of presentation position, the presentation component 230 may identify a specified location or position within the graphical user interface and within the set of presentation positions to be assigned as a first presentation position or the first portion of presentation positions.

In operation 350, the trigger component 240 determines a presentation trigger. The presentation trigger selects a connection type of a set of members to be presented to the specified member. The connection type may include connected members, unconnected members, members with attenuated connections, combinations thereof, or any other suitable connection type. The set of members may include at least one connected member of the set of connected members. In some embodiments, the trigger component 240 may select two or mote connection types for the set of members to be presented. The trigger component 240 may select a portion of the set of members having a first connection type and another portion of the set of members having a second connection type. For example, one or two members of the set of members may be unconnected members and the remaining members of the set of members may be connected members.

In some embodiments, the trigger component 240 determines the presentation trigger by identifying a presentation probability. The presentation probability may be determined for at least one presentation position of the set of presentation positions. In some embodiments, the presentation probability is a fixed value or threshold indicating a chance of presenting an unconnected member. For example, the presentation probability may be 0.5, indicating a fifty percent chance of presenting an unconnected member in the at least one presentation position and a fifty percent chance of presenting a connected member in the at least one presentation position. The presentation probability may be set to any suitable value or range of values, such as 0.2-0.8, to facilitate presentation of reconnected members or connected members. The trigger component 240 may randomly determine the presentation trigger based on the presentation probability. In some embodiments, the presentation probability is generated dynamically. The dynamic generation of the presentation probability may tailor presentation of unconnected members to the specified member to whom the unconnected members may be presented.

The trigger component 240 may determine the presentation trigger for each position of the set of presentation positions, for a single designated presentation position, for a dynamically determined presentation position, or for a subset of presentation positions of the set of presentation positions. In some embodiments, the trigger component 240 determines the presentation probability for the entire set of presentation positions. In such embodiments, the trigger component 240 identifies the presentation probability as a probability of triggering presentation of a specified connection type (e.g., unconnected members) among the members included within the set of members.

The trigger component 240 may trigger presentation of an unconnected member at the at least one presentation position. In some embodiments, the trigger component 240 triggers presentation of the unconnected member based on the presentation probability for the at least one presentation position. For example, the trigger component 240 may determine a value for the presentation trigger, the value may be compared to the presentation probability, and the comparison may trigger presentation of an unconnected member based on the value exceeding a threshold associated with the presentation probability. In some instances, the trigger component 240 determines the presentation trigger by generating a binary indicator (e.g., present or don't present) using a probability weight or otherwise based on the presentation probability.

In operation 360, the selection component 250 selects an unconnected member from the plurality of unconnected members for presentation within the set of members. In some embodiments, the selection component 250 selects the unconnected member based on the presentation trigger. For example, the selection component 250 may randomly select the unconnected member from the plurality of unconnected members in response to the trigger component 240 triggering presentation of an unconnected member.

In some embodiments, the selection component 250 selects the unconnected member by identifying a set of attributes for each unconnected member of the plurality of unconnected members. The set of attributes may comprise one or more of an educational background, a field of study, an employment history, an employment type, an employment field, a common member connection, an attenuated member connection, demographic information, a member history of interactions with the social network, a member history of topics or comments posted by the member, topics of interest of the member, or any other suitable attribute of the member, stored within the member profile, or discemable based on the profile of the member. The selection component 250 compares one or more selected attributes of the unconnected member to a set of attributes of the specified member. The selection component 250 identifies one or more of an attribute match, related attributes, or comparable attributes among the set of attributes of the unconnected member and the specified member. Where matching, related, or comparable attributes are identified and the trigger component 240 indicates presentation of an unconnected member, the selection component 250 selects the unconnected member associated with the matching, related, or comparable attributes for presentation to the specified member.

In some embodiments, the selection component 250 determines a relevance probability value for attributes of the specified member. The relevance probability value may be an indication of whether an attribute is likely to be relevant to the specified member in determining whether to form an association with an unconnected member. The selection component 250 may select attributes for determining relevance probability values based on the comparison of attributes of unconnected members and the specified member. For example, attributes of the unconnected member determined to match, relate to, or otherwise correspond to an attribute of the specified member may be selected for determining a relevance probability value. The selection component 250 may then determine the relevance probability value based on member interactions, connections, associations, or other actions of the specified member indicating a subjective value of the attribute. In such embodiments, the selection component 250 identifies similar attributes between the specified member and the unconnected member, and determines whether the similar attributes are of concern or interest to the specified member by generating the relevance probability value.

The selection component 250 may then select the unconnected member having a selected attribute corresponding to an attribute of the specified member with a relevance probability value above a relevance threshold. The relevance threshold may be a value above which the specified member is likely to select the unconnected member for connection. The relevance threshold may be dynamically determined for the specified member. For example, where a specified member has an interaction history of selecting members for connection with attributes having relevance probability values above 0.75, the selection component 250 may specify the relevance threshold at or near 0.75.

In operation 370, the presentation component 230 causes presentation of the unconnected member within a first presentation position of the set of presentation positions, and causes presentation of one or more connected members in one or more second presentation positions. The one or more connected members may be selected from the set of connected members identified in operation 330. The one or more connected members may be pushed or presented based on a relevance probability determined for attributes shared by the specified member and the one or more connected members of the set of connected members. The one or more connected members presented in the one or mere second presentation positions may have relevance probabilities above a specified threshold, or may have the top relevance probabilities among the set of connected members.

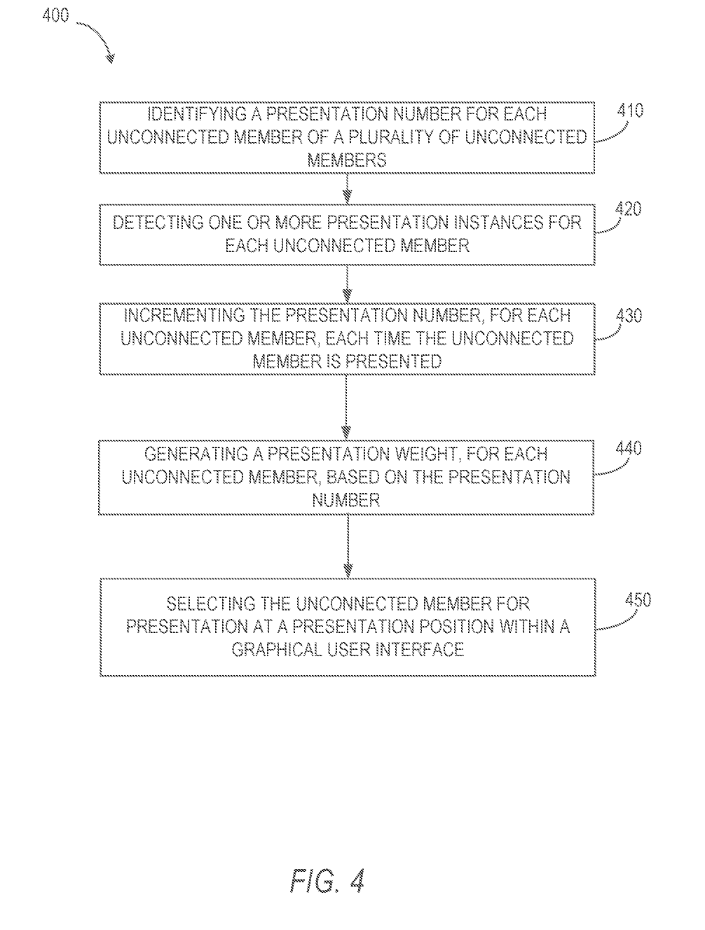

FIG. 4 is a flow diagram illustrating a method 400 of identifying and facilitating connections for unconnected members within a social network, consistent with various embodiments described herein. The method 400 may be performed, at least in part, by, for example, the network analysis machine 22 illustrated in FIG. 2 (or an apparatus having similar components, such as one or more client devices 8 or application servers). In some embodiments, the method 400 includes one or more operations from the method 300. In some instances, the method 400 is performed as a sub-operation or other part of operation 360.

In operation 410, the selection component 250 identifies a presentation number for each unconnected member of the plurality of unconnected members. The presentation number represents a number of times an unconnected member has been presented to other members having a suitable network of connections with other members of the social network. The presentation number may be stored in the profile of each unconnected member or a data set associated with the profiles of unconnected members (e.g., profile metadata). In some embodiments, the presentation number is weighted, notated, or otherwise modified to represent multiple instances of an unconnected member being presented to a single specified member of the social network. Where an unconnected member has been repeatedly presented to a certain member with no connection having been established, weighting of the presentation number may lower the likelihood of the unconnected member being presented to the certain member a subsequent time.

In operation 420, the selection component 250 detects one or more presentation instances for each unconnected member. The selection component 250 may detect a presentation instance each time an unconnected member is presented to another member of the social network. In some embodiments, presentation instances represent information of the unconnected member being depicted within a graphical user interface presented on a computing device of another member of the social network. The presentation instance may be selected where profile information of the unconnected member is transmitted to the computing device of the other member of the social network. Where the presentation instance is detected based on transmission of profile information of the unconnected member, the presentation instance may be detected regardless of presentation of the profile information on a viewable portion of a display device of the computing device of the other member

In operation 430, the selection component 250 increments the presentation number, for each unconnected member, each time the unconnected member is presented in a presentation position. The selection component 250 may increment the presentation number upon detection of the presentation instance in operation 420. In some instances, the selection component 250 increments the presentation number by generating an increment command to one or more of the user component 210 and the presentation component 230. The component receiving the increment command may modify a member profile or associated data of the unconnected member to increment the presentation number.

In operation 440, the selection component 250 generates a presentation weight, for each unconnected member, based on the presentation number. In some embodiments, in generating the presentation weight, the selection component 250 determines whether the presentation number exceeds a specified presentation threshold. The presentation threshold may be a value or number representing a threshold number of presentations of the unconnected member. In some instances, the presentation threshold is associated with an overall number of presentations. The presentation threshold may also be associated with a number of presentations to a specified or same member of the social network. In some embodiments, the presentation weight is configured to suppress presentation of the unconnected member. The presentation weight may suppress presentation of the unconnected member, after the presentation number has passed the presentation threshold, to enable other unconnected members to be presented.

In operation 450, the selection component 250 selects the unconnected member for presentation at a presentation position within the graphical user interface In some embodiments, the unconnected member is selected based on the presentation number of each unconnected member. For example, an unconnected member with a lowest presentation number may be selected for presentation. An unconnected member with a higher presentation number may be selected based on a relevancy value, an attribute match, or other factors described above with respect to FIG. 3. The unconnected member may be selected based on the presentation weight of the unconnected member. Where a plurality of unconnected members is available for connection, the unconnected member may be selected based on the presentation weight of each unconnected member. For example, the unconnected member with the lowest presentation weight (e.g., a presentation weight indicating a small number of presentations or a number of presentations below or near the presentation threshold) or a comparatively low presentation weight may be selected. In some instances, the unconnected member is selected based on a combination of the presentation number and the presentation weight.

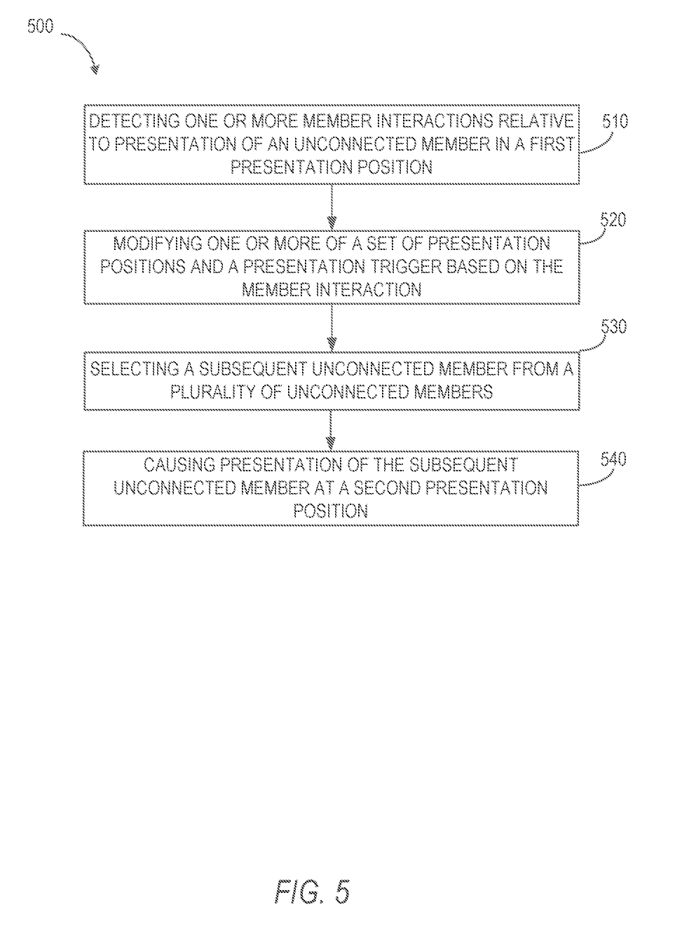

FIG. 5 is a flow diagram illustrating an example method 500 of identifying and facilitating connections for unconnected members within a social network, consistent with various embodiments described herein. The method 500 may be performed, at least in part, by, for example, the network analysis machine 22 illustrated in FIG. 2 (or an apparatus having similar components, such as one or more client devices 8 or application servers). In some embodiments, the method 500 is performed as a sub-operation or other pan of the methods 300 or 400. In some instances, the method 500 is performed as one or more sub-operations of operation 370 or in response to operation 370.

In operation 510, the interaction component 260 detects one or more member interactions of the specified member relative to presentation of the unconnected member within the first presentation position. The one or more member interactions may include selection of an icon corresponding to a presentation position containing information for an unconnected member. In some instances, the one or more interactions include selection of one or more icons corresponding to presentation positions containing information for connected members. Where the one or more interactions correspond to connected members, without selection of the unconnected member, the one or more interactions may be tracked over a period of time to indicate absence of interest in the presented unconnected member.

In operation 520, the presentation component 230 modifies one or more of the set of presentation positions and the presentation trigger. In some embodiments, the set of presentation positions and the presentation trigger are modified based on the one or more member interactions detected by the interaction component 260. For example, the presentation component 230 may modify the one or more presentation positions or the presentation trigger in response to selection of or interaction with the icon corresponding to the unconnected member. Modification of the presentation positions may include removal of the icon associated with the unconnected member, or substitution of the selected icon or information depicted in the icon with a subsequent icon or information of a subsequent unconnected member.

In operation 530, the selection component 250 selects a subsequent unconnected member from the plurality of unconnected members. In some embodiments, the subsequent unconnected member is selected in a manner similar to or the same as that described above with respect to operation 360. The selection component 250 may select the subsequent unconnected member from the plurality of unconnected members by identifying a presentation number of the unconnected member presented relative to operation 410 or 510. The selection component 250 may then determine presentation numbers of the remaining unconnected members of the plurality of unconnected members. The selection component 250 may select an unconnected member with a higher presentation number as the subsequent unconnected member. In some embodiments, the selection component 250 selects the subsequent unconnected member based on the unconnected member presented relative to operation 510. For example, the selection component 250 may identify characteristics or aspects of unconnected members of the plurality of unconnected members. The selection component 250 may compare aspects or characteristics of the plurality of unconnected members with aspects or characteristics of the previously presented unconnected member. The subsequent unconnected member may be selected as an unconnected member of the plurality of unconnected members who is determined to be most similar to the previously presented unconnected member. In some embodiments, the subsequent unconnected member may be selected randomly from the plurality of unconnected members. Although selection of the subsequent unconnected member has been described with respect to certain specified embodiments, it should be understood that the selection component 250 may select the subsequent unconnected members according to one or more methodologies, considerations, aspects, characteristics, relationships, previous presentations, or other means.

In operation 540, once the subsequent unconnected member has been selected, the presentation component 230 causes presentation of the subsequent unconnected member at a second presentation position of the set of presentation positions. In some embodiments, the presentation component 230 causes presentation of the subsequent unconnected member in a manner similar to or the same as that described above with respect to operation 370. The presentation component 230 may cause presentation of the subsequent unconnected member in the presentation position previously identified with or associated with the previously presented or selected unconnected member. In some embodiments, the presentation component 230 may select a different presentation position than that used for the previously presented unconnected member. The second presentation position may be selected randomly, according to a predefined selection scheme, or based on a number of times the specified member has selected unconnected members in each presentation position. Although presentation of the subsequent unconnected member has been described with specified embodiments, it should be understood that the presentation component 230 may cause presentation of the subsequent unconnected member at any suitable presentation position.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented components or objects that operate to perform one or more operations or functions. The components and objects referred to herein may, in some example embodiments, comprise processor-implemented components and/or objects.

Similarly, the methods described herein may be at least partially processor-implemented. For example, at least some of the operations of a method may be performed by one or more processors or processor-implemented components. The performance of certain operations may be distributed among the one or more processors, not only residing within a single machine or computer, but deployed across a number of machines or computers. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g. the Internet) and via one or more appropriate interfaces (e.g., APIs).

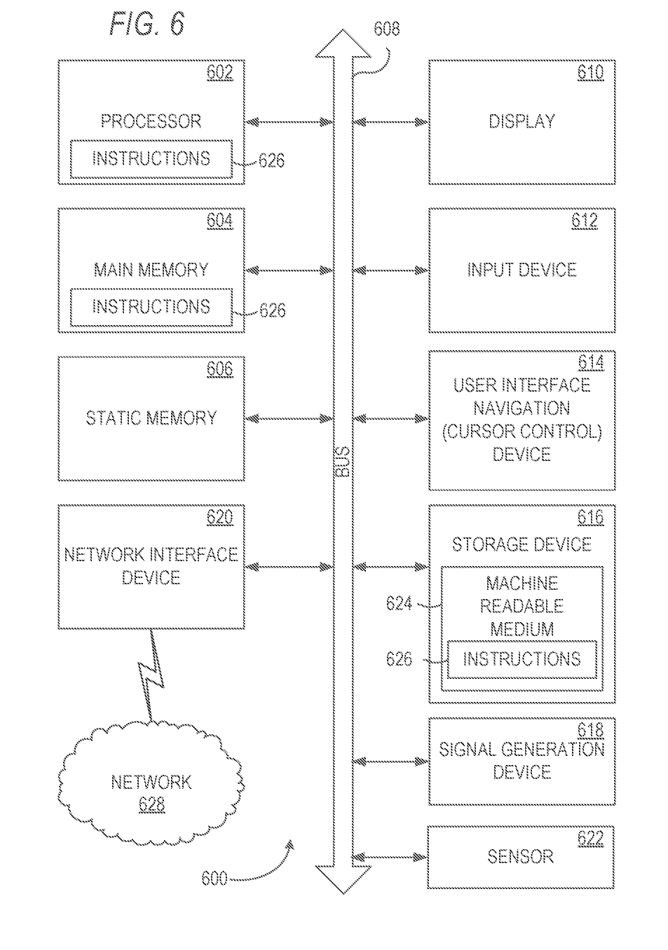

FIG. 6 is a block diagram of a machine in the form of a computer system 600 within which a set of instructions, for causing the machine to perform any one or more of the methodologies discussed herein, may be executed. For example, the computer system 600 may he a server functioning as the network analysis machine 22. In some instances, the computer system 600 may be a set of similar computing devices storing instructions capable of configuring a processor of the computer system 600 as one or more of the components (hardware-software implemented components) described above. The configuration of a component, even for a period of time, causes the computer system 600 to act as a special-purpose computing device for performing one or more operations associated with the component, as described in the present disclosure. In some embodiments, the computer system 600 may function as the social networking system 10, with portions (e.g., hardware and instructions) partitioned to function as one or more of the components, interfaces, or systems described above during specified operations associated with those aspects of the components, interfaces, and systems.

In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In various embodiments, the machine may be a server computer; however, in alternative embodiments, the machine may be a personal computer (PC), a tablet PC, a set-top box (STB), a personal digital assistant (PDA), a mobile telephone, a web appliance, a network router, a network switch, a network bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 600 includes a processor 602 (e.g. a central processing unit (CPU), a graphics pressing unit (GPU), or both), a main memory 604, and a static memory 606, which communicate with each other via a bus 608. The computer System 600 may further include a display unit 610, an alphanumeric input device 612 (e.g., a keyboard), and a user interface (UI) navigation device 614 (e.g., a mouse). In one embodiment, the display unit 610, alphanumeric input device 612, and UI navigation device 614 are a touch screen display. The computer system 600 may additionally include a storage device 616 (e.g., drive unit, processor-readable storage device, or memory), a signal generation device 618 (e.g., a speaker), a network interface device 620, and one or more sensors 622, such as a Global Positioning System sensor, compass, accelerometer, or other sensor.

The storage device 616 includes a machine-readable medium 624 on which is stored one or more sets of instructions 626 and data structures embodying or utilized by any one or more of the methodologies or functions described herein. The instructions 626 (e.g., processor-executable instructions) may also reside, completely or at least partially, within the main memory 604 (e.g., non-transitory machine-readable storage medium) and/or within the processor 602 during execution thereof by the computer system 600, with the main memory 604 and the processor 602 also constituting machine-readable media 624.

While the machine-readable medium 624 is illustrated in an example embodiment to be a single medium, the term “machine-readable medium” may include a single medium or multiple media (e.g., a centralized or distributed database, and/or associated caches and servers) that store the one or more instructions 626. The term “machine-readable medium” shall also be taken to include any tangible medium that is capable of storing, encoding, or carrying the instructions 626 for execution by the machine and that cause the machine to perform any one or more of the methodologies of the present disclosure, or that is capable of storing, encoding, or carrying data structures utilized by or associated with such instructions 626. The term “machine-readable medium” shall accordingly be taken to include, but not be limited to, solid-state memories, and optical and magnetic media. Specific examples of machine-readable media 624 include non-volatile memory, including by way of example semiconductor memory devices, e.g., erasable programmable read-only memory (EPROM), electrically erasable programmable read-only memory (EEPROM), and flash memory devices, magnetic disks such as internal hard disks and removable disks, magneto-optical disks, and compact disk read only memory (CD-ROM) and digital video disk read only memory (DVD-ROM) disks.

The instructions 626 may further be transmitted or received over a communication network 628 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., Wi-Fi® and WiMax® networks). The term “transmission medium” shall be taken to include any intangible medium that is capable of storing, encoding, or carrying the instructions 626 for execution by the machine, and includes digital or analog communications signals or other intangible media to facilitate communication of such software.

Although embodiments have been described with reference to specific examples, it will be evident that various modifications and changes may be made to these embodiments without departing from the broader scope of the inventive concepts of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
identifying a plurality of unconnected members having a number of associations below a first association threshold;
identifying a specified member having a number of associations above a second association threshold,
determining one or more connected members having an attenuated association with the specified member;
identifying a set of presentation positions within a graphical user interface presented to the specified member, the set of presentation positions configured for presenting member information of a plurality of members to the specified member;
determining a presentation trigger selecting a connection type of a set of members to be presented to the specified member, the set of members including at least one connected member of the one or more connected members.
based on the presentation trigger, selecting an unconnected member from the plurality of unconnected members for presentation within the set of members; and
causing presentation of the unconnected member within a first presentation position of the set of presentation positions and the at least one connected member in one or more second presentation positions.

2. The method of claim 1 further comprising:
identifying a first set of members within the plurality of members, the first set of members being associated with a number of other members below the second association threshold, and
assigning the first set of members to an association pool.

3. The method of claim 1, wherein the attenuated association is an indirect association between the one or more connected members and the specified member, the indirect association including at least one intervening member serving to connect the one or more connected members with the specified member.

4. The method of claim 3, wherein one or more unconnected members of the plurality of unconnected members are associated with a connected member of the one or more connected members.

5. The method of claim 1, wherein determining the presentation trigger further comprises.
identifying a presentation probability for at least one presentation position of the set of presentation positions; and
based on the presentation probability for the at least one presentation position, triggering presentation of an unconnected member at the at least one presentation position.

6. The method of claim 1, wherein selecting the unconnected member further comprises.
identifying a set of attributes for each unconnected member of the plurality of unconnected members;
determining a relevance probability value of each attribute to the specified member, and
selecting the unconnected member having a selected attribute with a relevance probability value above a relevance threshold.

7. The method of claim 1, wherein selecting the unconnected member further comprises:
identifying a presentation number for each unconnected member of the plurality of unconnected members; and
based on the presentation number of each unconnected member, selecting the unconnected member for presentation at a presentation position within the graphical user interface.

8. The method of claim 7, wherein selecting the unconnected member based on the presentation number further comprises.
detecting one or more presentation instances for each unconnected member;
for each unconnected member, incrementing the presentation number each time the unconnected member is presented in a presentation position;
for each unconnected member, generating a presentation weight based on the presentation number, and
selecting the unconnected member based on the presentation weight of the unconnected member.

9. The method of claim 1 further comprising:
detecting one or more member interactions of the specified member relative to presentation of the unconnected member within the first presentation position;
based on the one or more member interactions, modifying one or more of the set of presentation positions and the presentation trigger; and
selecting a subsequent unconnected member from the plurality of unconnected members and presenting the subsequent unconnected member at a subsequent presentation position of the set of presentation positions.

10. A system, comprising:
one or more processors; and
a processor-readable storage device comprising processor-executable instructions that, when executed by the one or more processors, cause the one or more processors to perform operations comprising:
identifying a plurality of unconnected members having a number of associations below a first association threshold;
identifying a specified member having a number of associations above a second association threshold;
determining one or more connected members having an attenuated association with the specified member;
identifying a set of presentation positions within a graphical user interface presented to the specified member, the set of presentation positions configured for presenting member information of a plurality of members to the specified member;
determining a presentation trigger selecting a connection type of a set of members to be presented to the specified member, the set of members including at least one connected member of the one or more connected members;
based on the presentation trigger, selecting an unconnected member from the plurality of unconnected members for presentation within the set of members; and
causing presentation of the unconnected member within a first presentation position of the set of presentation positions and the at least one connected member in one or more second presentation positions.

11. The system of claim 10, wherein the operations further comprise.
identifying a first set of members within the plurality of members, the first set of members being associated with a number of other members below the second association threshold; and
assigning the first set of members to an association pool.

12. The system of claim 10, wherein determining the presentation trigger further comprises:
identifying a presentation probability for at least one presentation position of the set of presentation positions; and
based on the presentation probability for the at least one presentation position, triggering presentation of an unconnected member at the at least one presentation position.

13. The system of claim 10, wherein selecting the unconnected member further comprises:
identifying a set of attributes for each unconnected member of the plurality of unconnected members;
determining a relevance probability value of each attribute to the specified member, and
selecting the unconnected member having a selected attribute with a relevance probability value above a relevance threshold.

14. The system of claim 10, wherein the operations further comprise:
detecting one or more member interactions of the specified member relative to presentation of the unconnected member within the first presentation position;
based on the one or more member interactions, modifying one or more of the set of presentation positions and the presentation trigger; and
selecting a subsequent unconnected member from the plurality of unconnected members and presenting the subsequent unconnected member at a second presentation position of the set of presentation positions.

15. A processor-readable storage device comprising processor-executable instructions that, when executed by one or more processors of a machine, cause the machine to perform operations comprising:
identifying a plurality of unconnected members having a number of associations below a first association threshold;
identifying a specified member having a number of associations above a second association threshold;
determining one or more connected members having an attenuated association with the specified member;
identifying a set of presentation positions within a graphical user interface presented to the specified member, the set of presentation positions configured for presenting member information of a plurality of members to the specified member;
determining a presentation trigger selecting a connection type of a set of members to be presenteed to the specified member, the set of members including at least one connected member of the one or more connected members;
based on the presentation trigger, selecting an unconnected member from the plurality of unconnected members for presentation within the set of members; and
causing presentation of the unconnected member within a first presentation position of the set of presentation positions and the at least one connected member in one or more second presentation positions.

16. The processor-readable storage device of claim 15, wherein the operations further comprise:
identifying a first set of members within the plurality of members, the first set of members being associated with a number of other members below the second association threshold; and
assigning the first set of members to an association pool.

17. The processor-readable storage device of claim 15, wherein determining the presentation trigger further comprises:
identifying a presentation probability for at least one presentation position of the set of presentation positions; and
based on the presentation probability for the at least one presentation position, triggering presentation of an unconnected member at the at least one presentation position.

18. The processor-readable storage device of claim 15, wherein selecting the unconnected member further comprises:
identifying a set of attributes for each unconnected member of the plurality of unconnected members;
determining a relevance probability value of each attribute to the specified member; and
selecting the unconnected member having a selected attribute with a relevance probability value above a relevance threshold.

19. The processor-readable storage device of claim 15, wherein selecting the unconnected member further comprises:
identifying a presentation number for each unconnected member of the plurality of unconnected members;
detecting one or more presentation instances for each unconnected member;
for each unconnected member, incrementing the presentation number each time the unconnected member is presented in a presentation position;
for each unconnected member, generating a presentation weight based on the presentation number; and
based on the presentation number and the presentation weight of each unconnected member, selecting the unconnected member for presentation at a presentation position within the graphical user interface.

20. The processor-readable storage device of claim 15, wherein the operations further comprise:
detecting one or more member interactions of the specified member relative to presentation of the unconnected member within the first presentation position;
based on the one or more member interactions, modifying one or more of the set of presentation positions and the presentation trigger; and
selecting a subsequent unconnected member from the plurality of unconnected members and presenting the subsequent unconnected member at a second presentation position of the set of presentation positions
